(19) United States
(12) Patent Application Publication
(10) Pub. No.: US 2012/0050417 A1
(43) Pub. Date: Mar. 1, 2012

(54) Printing device having supply of colorant that is non-refillable and at least substantially non-removable from end user perspective

(76) Inventors: David Olsen, Corvallis, OR (US); Kevin D. Almen, Albany, OR (US); Marc A. Baldwin, Corvallis, OR (US); Patrick Therien, Camas, WA (US); Tony S. Cruz-Uribe, Corvallis, OR (US)

(21) Appl. No.: 13/189,429

(22) Filed: Jul. 22, 2011

Related U.S. Application Data
(63) Continuation-in-part of application No. 11/738,370, filed on Apr. 20, 2007.

(51) Int. Cl. B41J 2/175

(52) U.S. Cl. 347/85

(57) ABSTRACT

A printing device includes a supply of colorant that is non-refillable from an end user perspective and that is at least substantially non-removable from the printing device from the end user perspective. The printing device also includes a printing mechanism that forms images on media using the supply of colorant.

### RELATED PATENT APPLICATIONS

The present patent application is a continuation-in-part of the previously filed patent application having the same name, filed on Apr. 20, 2007, and assigned Ser. No. 11/738,370.

The present patent application is related to the patent application entitled “Print device having supply of colorant and receptive to print cartridge having self-contained supply of colorant,” filed on Apr. 20, 2007, and assigned Ser. No. 11/738,722.

### BACKGROUND

Inkjet printing devices eject ink onto media to form images on the media. Inkjet printing devices typically have removably inserted print cartridges that contain the ink which is used to form images on media. The ink lasts a given number of media sheets, and once depleted the print cartridge has to be replaced with a new print cartridge containing a new supply of ink. A common complaint of users is that print cartridges have to be replaced relatively frequently as their supplies of ink are depleted, and are susceptible to theft in multiple-user environments such as office environments and public places like libraries.

### BRIEF DESCRIPTION OF THE DRAWINGS

FIG. 1 is a block diagram of a printing device, according to an embodiment of the invention.

FIGS. 2A and 2B are diagrams showing how internal colorant supplies can be permanently affixed or disposed within a printing device, according to an embodiment of the invention.

FIG. 3 is a diagram of a printing device in which an internal colorant supply can be fluidically coupled to a carriage, according to an embodiment of the invention.

FIG. 4 is a diagram depicting how a print cartridge can be fluidically coupled to an internal colorant supply of a printing device, according to an embodiment of the invention.

FIG. 5 is a diagram depicting the fluidic coupling of FIG. 4 in more detail, according to an embodiment of the invention.

FIG. 6 is a diagram depicting how a print cartridge can be fluidically coupled to an internal colorant supply of a printing device, according to another embodiment of the invention.

FIG. 7 is a flowchart of a method related to a printing device having an internal colorant supply that is permanently affixed within the device and is non-refillable from the perspective of an end user, according to an embodiment of the invention.

### DETAILED DESCRIPTION OF THE DRAWINGS

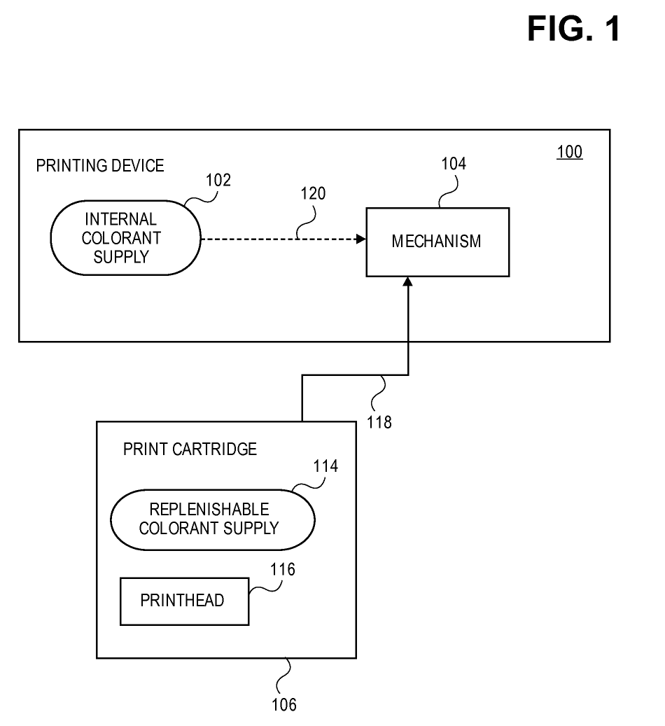

FIG. 1 shows a block diagram of a printing device 100, according to an embodiment of the invention. The printing device 100 is depicted in FIG. 1 as including an internal colorant supply 102 and a mechanism 104, which may be a carriage that moves across a sheet of media in a direction perpendicular to a direction in which the media sheet is advanced through the printing device 100, as can be appreciated by those of ordinary skill within the art. The mechanism 104 is receptive to removable insertion of a print cartridge 106. As can also be appreciated by those of ordinary skill within the art, the printing device 100 typically includes other components besides those depicted in FIG. 1, such as the rollers, motors, and so on, that, for instance, advance sheets of media through the printing device 100.

The internal colorant supply 102 may be ink, such as a bag or a box of ink, such that the printing device 100 is an inkjet-printing device that forms images on media using an inkjet printhead. The internal colorant supply 102 is external to the print cartridge 106 that is insertable into the printing device 100. While the printing device 100 is depicted as including one such colorant supply 102, there may be more than one supply of colorant. For example, for the printing device 100 to form full-color images on media, the device 100 may include a black colorant supply, a cyan colorant supply, a magenta colorant supply, and a yellow colorant supply. The colorant supply 102 is at least substantially permanently disposed within the printing device 100. That is, it may be attached to the printing device 100 during manufacture of the device 100, and not intended for replacement by the end user. Furthermore, the colorant supply 102 can be non-refillable, in that once the colorant has been exhausted, it may not be practical or be able to be refilled by the end user. The internal colorant supply 102 may have a sufficiently large volume of colorant so that the printing device 100 can form images using colorant from the colorant supply 102 for the projected (i.e., rated) life of the device 100.

More generally, the internal colorant supply 102 is not constructed or designed to be serviceable by the end user that purchased and/or is using the printing device 100. From the standpoint of the end user (i.e., from the end user's perspective), the colorant supply 102 is non-refillable and at least substantially non-removable from the printing device 100. Once the end user has purchased the printing device 100, he or she does not and substantially cannot refill the colorant supply 102, nor remove it from the printing device 100. That is, the internal colorant supply 102, from the end user's perspective, is non-refillable and is permanently affixed to the printing device 100.

As has been noted, the mechanism 104 may be a carriage, which may have one or more slots receptive to removable insertion of print cartridges, such as the print cartridge 106. The print cartridge 106 may include a replenishable colorant supply 114, such as ink, and/or a printhead 116, such as an inkjet printhead. When the print cartridge 106 is inserted into the mechanism 104, as indicated by the arrow 118, the printing device 100 forms images on media by the printhead 116 initially using colorant from the replenishable colorant supply 114. As the colorant within the replenishable colorant supply 114 is used, however, the internal colorant supply 102 replenishes the colorant supply 114, via a fluidic connection between the internal colorant supply 102 and the print cartridge 106 removably inserted within the mechanism 104, as indicated by the dotted arrow 120.

For instance, the printing device 100 may be shipped with and be sold to consumers as including the print cartridge 106. The print cartridge 106 is removably inserted into the mechanism 104 at the beginning of its life, such as by an end user. In another embodiment, the print cartridge 106 is permanently or otherwise installed within the printing device 100 prior to selling the device 100 to an end user, such as during manufacturing of the device 100, so that the end user does not have to install the cartridge 106. As the colorant supply 114 within the print cartridge 106 is used, it is replenished by the internal colorant supply 102. Therefore, where the internal colorant supply 102 contains sufficient colorant for the projected (i.e., rated) life of the printing device 100, the print cartridge 106 will be able to be used to form images on media, and will not have to be replaced, for this period of time.

It is noted that in one embodiment, the print cartridge 106 may not include the replenishable colorant supply 114 or the printhead 116. Where the print cartridge 106 does not include the colorant supply 114, the internal colorant supply 102, via fluidic connection to the print cartridge 106 removably inserted into the mechanism 104, as indicated by the dotted arrow 120, immediately provides the colorant by which the printhead 116 forms images on media. Where the print cartridge 106 does not include the printhead 116, the printing device 100 may include a separate inkjet printhead, which may be removably or permanently attached within the device 100.

Thus, it can be said that the print cartridge 106 at least ultimately uses the internal colorant supply 102 of the printing device 100 to form images on media. Where the print cartridge 106 includes its own self-contained, but replenishable, colorant supply 114, images are formed on media using colorant from this colorant supply 114, but the colorant supply 114 is replenished with colorant from the colorant supply 102 of the printing device 100 as these images are formed. As such, the internal colorant supply 102 is indirectly and ultimately used to form images on media. By comparison, where the print cartridge 106 lacks its own self-contained colorant supply 114, images are formed on media using colorant supply 102 of the printing device 100 directly.

It is also noted that there may be more than one print cartridge 106. For example, there may be a black print cartridge, a cyan print cartridge, a yellow print cartridge, and a magenta print cartridge. Each such print cartridge 106 may include a correspondingly colored replenishable colorant supply 114, and an inkjet printhead 116. In another embodiment, there may be two print cartridges 106: a black print cartridge 106 having a black colorant supply 114, and a color print cartridge 106 having, for example, cyan, magenta, and yellow colorant supplies 114. Once the internal colorant supply 102 of the printing device 100 has been exhausted due to formation of images on media, the replenishable colorant supply 114 of the print cartridge 106 is no longer able to be replenished with colorant from the internal colorant supply 102.

In one embodiment, the internal colorant supply 102 may be initially filled with the same amount of colorant regardless of the end user. This amount of colorant may the amount that the manufacturer of the printing device 100 has determined is sufficient to last for a predetermined length of time based on predetermined usage characteristics. For instance, the amount of colorant may be sufficient to last 95% of end users at least a number of years. In another embodiment, the internal colorant supply 102 may be initially filled with an amount of colorant as requested by the end user. For example, when ordering the printing device 100, the end user may request how much colorant he or she wishes to initially purchase, such that the colorant supply 102 that is provided is equal to this amount of colorant. The end user may, for instance, indicate that he or she would like to purchase three years worth of colorant based on expected averaged usage of the printing device 100. In this way, the end user may be able to purchase the amount of colorant he or she expects to use for a given length of time, based on expected usage of the printing device 100.

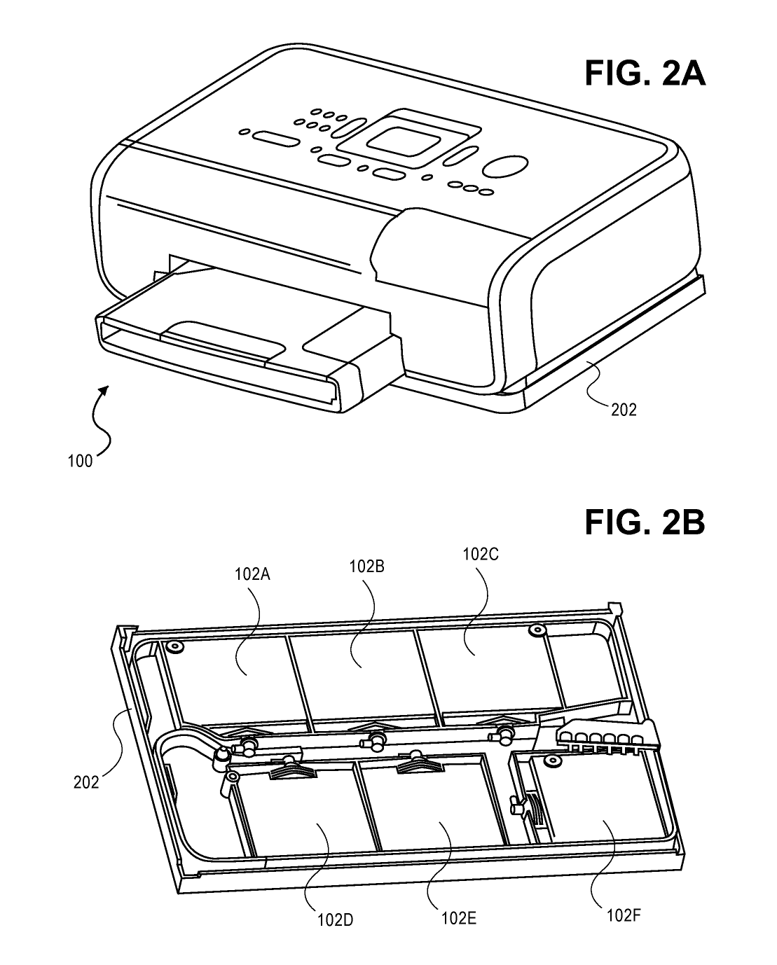

FIGS. 2A and 2B show how the internal colorant supply 102 may be permanently affixed within the printing device 100, according to an embodiment of the invention. In FIG. 2A, a representative printing device 100 is shown that includes a bottom tray 202. In FIG. 2B, six individual internal colorant supplies 102A, 102B, 102C, 102D, 102E, and 102F, which together constitute the internal colorant supply 102, are at least permanently disposed within the bottom tray 202. The individual colorant supplies 102 are particularly bags of ink, and may include bags of black, cyan, light cyan, yellow, magenta, and light magenta ink, for instance. There may be less or more than six such individual colorant supplies 102 in one embodiment. For example, there may be just four individual colorant supplies 102, including bags of cyan, magenta, yellow, and black ink.

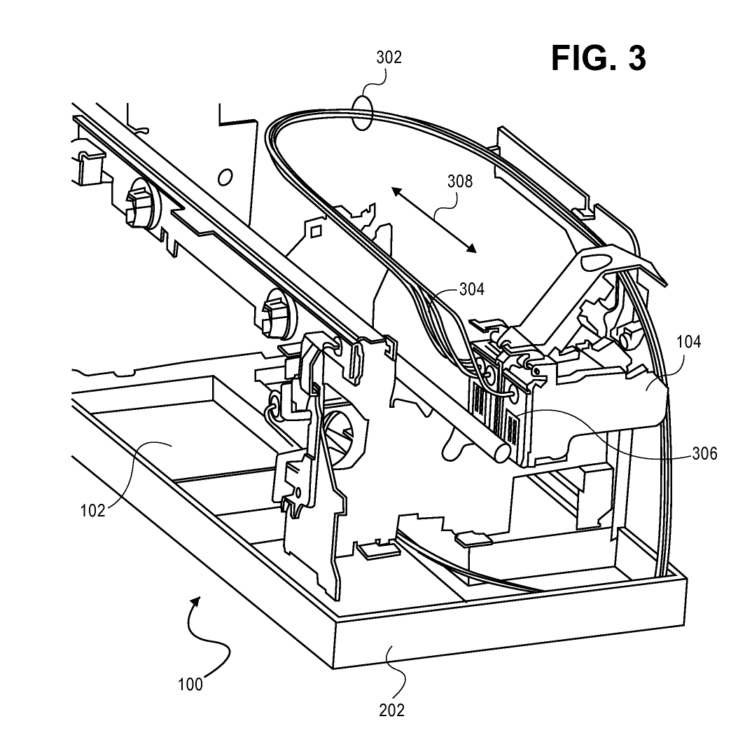

FIG. 3 shows how internal colorant supplies 102 of the printing device 100 can be delivered to the mechanism 104 for potential fluidic connection to print cartridges 304 and 306, according to an embodiment of the invention. One of the internal colorant supplies 102 is particularly shown within the tray 202 in FIG. 3. The print cartridge 304 is a color print cartridge capable of ejecting cyan, magenta and yellow ink, whereas the print cartridge 306 is a black print cartridge capable of ejecting black ink. The print cartridges 304 are inserted within the mechanism 104, which is a carriage capable of moving in the directions indicated by the bi-directional arrow 308 back and forth across media. The body of the carriage is not depicted in FIG. 3 for illustrative clarity.

Tubing 302 delivers the ink from the internal colorant supplies 102 to the mechanism 104. It can be said, therefore, that the tubing 302 fluidically connects, or couples, the colorant supplies 102 to the mechanism 104. The tubing 302 includes individual tubes for each of the colors of ink. Thus, there may be four tubes: one for cyan ink, one for magenta ink, one for yellow ink, and one for black ink. The print cartridges 304 and 306 are instances of the print cartridge 106, such that the print cartridges 304 and 306 interface with the tubing 302 to become fluidically connected with the ink of the colorant supplies 102.

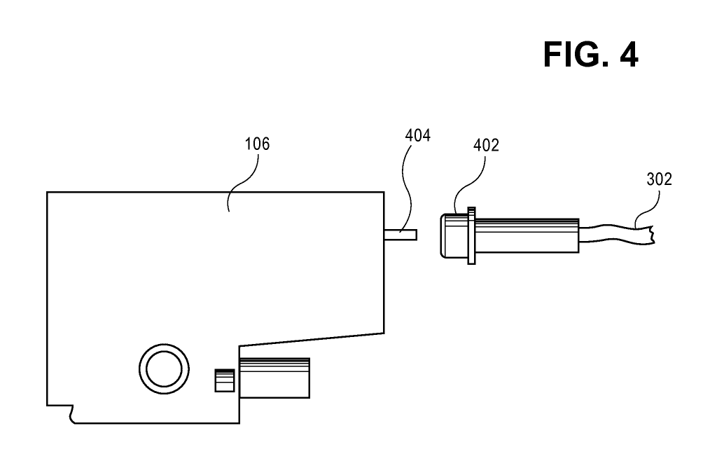

FIG. 4 shows how the print cartridge 106 can be fluidically connected to the internal colorant supply 102 of the printing device 100 of FIG. 3, according to an embodiment of the invention. The tubing 302 originating from the internal colorant supply 102 is terminated at the mechanism 104 by a septum 402, where the supply 102 and the mechanism 104 are not particularly depicted in FIG. 4. By comparison, the print cartridge 106 includes a hollow needle 404. Removable insertion of the print cartridge 106 into the printing device 100 results in the hollow needle 404 piercing the septum 402 to fluidically connect or couple the print cartridge 106 with the internal colorant supply 102 via the tubing 302. It is noted that this “make-break” fluid connection between the cartridge 106 and the tubing 302 is particular to one embodiment, and not all embodiments, of the invention. For instance, in other embodiments, the print cartridge 106 may be permanently fluidically connected to the tubing 302, such that the fluidic connection is not easily broken as with a septum 402/hollow needle 404 configuration.

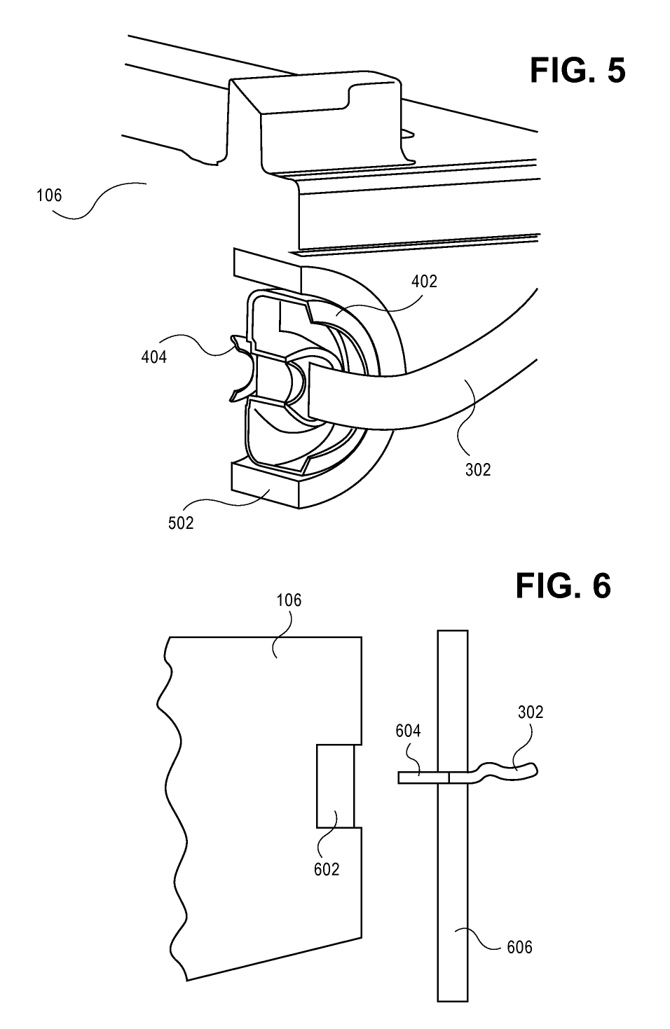

FIG. 5 shows a portion of the print cartridge 106 of FIG. 4 in more detail, according to an embodiment of the invention. The print cartridge 106 includes an absorptive interface 502, such as an absorptive material like a rigid sintered plastic filter, a bonded polyester fiber filter, and/or another type of capillary material or other material, that at least substantially surrounds the septum 402 upon removable insertion of the cartridge 106 into the mechanism 104 of the printing device 100. The absorptive interface 502 absorbs any colorant escaping from the septum 402, such as outside of the hollow needle 404 of the print cartridge 106. In one embodiment, the absorptive interface 502 itself, where rigid, may provide the fluidic connection with the colorant supply 102, without having to include a septum and needle.

FIG. 6 shows how the print cartridge 106 can be fluidically connected to the internal colorant supply 102 of the printing device 100 of FIG. 3, according to another embodiment of the invention. The tubing 302 originating from the internal colorant supply 102 is terminated at a manifold 606 of the mechanism 104 by a needle 604, where the supply 102 and other parts of the mechanism 104 are not particularly depicted in FIG. 6. By comparison, the print cartridge 106 includes a septum 602. Removable insertion of the print cartridge 106 into the printing device 100 results in the hollow needle 604 piercing the septum 602 to fluidically connect or couple the print cartridge 106 with the internal colorant supply 102 via the tubing 302.

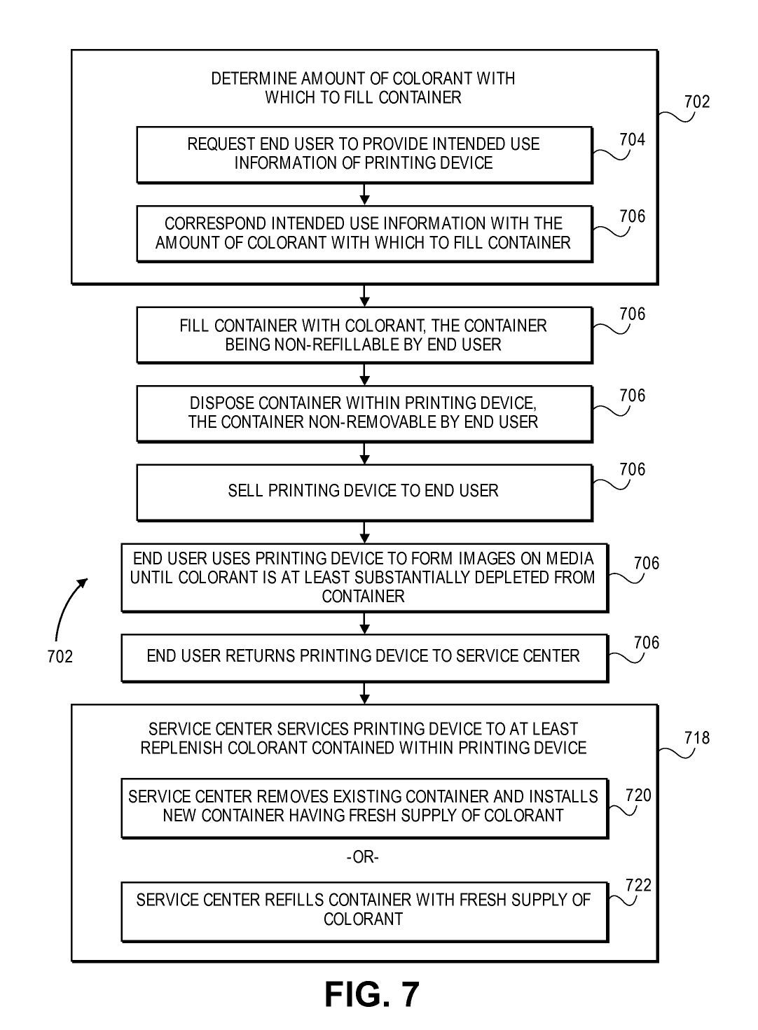

FIG. 7 shows a method 700, according to an embodiment of the invention. The various parts, steps, and/or acts of the method 700 are presented in a particular order in FIG. 7. However, this particular order is specific to just one embodiment of the invention, and other embodiments of the invention may depart from this order. For instance, the container may be filled with colorant in part 708 prior to the end user being requested to provide intended use information in part 704, where the end user is able to select from a number of different printing devices that are at least substantially identical to one another but for the amounts of colorant they contain.

Therefore, the method 700 in one embodiment begins by determining the amount of colorant with which to fill a container to be disposed within a printing device (702). The container may be a bag or a box, for instance. In one embodiment, at the time of purchase or ordering of the printing device, the end user is requested to provide intended use information regarding the printing device (704). This intended use information is corresponded with the amount of colorant with which to fill the container (706).

For example, the user may provide at the time of ordering of the printing device one or more of the following pieces of information: how the printing device will be used to form images on media, how often the printing device will be used to form images on media, and/or how long the end user wants the colorant within the container to last. How the printing device will be used may entail, for instance, whether the user will primarily print photos or color-intensive images using the printing device, whether the user will primarily print black-and-white text-oriented documents using the printing device, and so on. A number of such options may be provided to the user, such that the user selects the option that most closely corresponds to how the user anticipates that the printing device will be used. This information can be provided online via a web site of the seller or manufacturer of the printing device, over the phone, or in person.

How often the printing device will be used to form images on media may entail, for instance, how many pages the user is likely to print on a daily, weekly, and/or monthly basis. The user may be presented with options corresponding to average, light, and heavy usage, for instance, or may be able to particularly specify the number of pages that he or she will be printing within a given time period. How long the end user wants the colorant within the container to last may entail indicating a number of months or years that the end user wants to use the printing device without having to ever replenish the colorant within the container. The user may be allowed to enter a period of time up to a maximum period of time. The maximum period of time may correspond to a maximum amount of colorant that can be filled into the container, where such colorant is depleted at a given rate based on how the printing device will be used and/or how often the printing device will be used.

The end user may provide intended use information that is based on historical usage data of other printing devices that the end user has employed, which is particularly relevant where the end user is an organization like a corporation that tracks historical colorant usage. The end user may further be able to provide intended use information that is directed to a special purpose corresponding to a particular usage scenario. For example, the printing device may be ordered for usage by a student who is entering college, such that it is desired that the printing device contain sufficient colorant to last the typical four or five year period that it takes for the student to earn a bachelor's degree, based on typical student usage of the printing device. Other types of intended use information may also be provided by the end user.

In one embodiment, the intended use information is not explicitly provided by the end user to the manufacturer or seller of the printing device, such as over the phone, via a web site, or in person, but is implicitly provided by the end user. For example, an end user shopping in a store for a printing device may be able to select from printing devices that are instances of the same printing device, but that have been pre-filled with different amounts of colorant. The packaging for each such printing device may notify the potential purchaser as to the amount of colorant contained within the printing device. For example, one printing device may have packaging indicating that its supply of colorant will last an average printing device user for three years, while another printing device may have packaging indicating that its colorant supply will last a light printing device user for five years. The end user thus implicitly provides intended use information when selecting one of these printing devices insofar as the user selects the printing device that has been pre-filled with an amount of colorant corresponding to the user's anticipate usage of the printing device.

Thus, the intended use information explicitly or implicitly provided by the user is corresponded with the amount of colorant with which to fill the container (706). For example, where the user has provided intended use information as to how the printing device will be used, how often the device will be used, and how long the end user wants to use the device, this information can be entered into an equation or looked up against one or more tables to determine how much colorant with which the container should be filled. It is noted, therefore, that the container may not be filled with the maximum amount of colorant it can contain. This is advantageous, insofar as the end user is likely to purchase the printing device at a price inclusive of both the hardware of the printing device and the colorant contained within the printing device.

As such, the more colorant contained within the printing device, the more expensive the printing device is likely to be. Therefore, filling the container with less colorant than the maximum amount of colorant the container can contain means that the end user is purchasing just the amount of colorant that he or she needs or wants, such that the end user is purchasing the lowest-cost combination of a printing device and a colorant supply that satisfies the needs or wants of the end user. As another example, the balance of the different colors of colorant can be adjusted based on the end user's preference. For instance, if the end user anticipates printing significantly more using just black-and-white images and text than full-color images and text, an expanded container for black colorant can be employed, and smaller-sized containers for other colors of colorant can be employed.

Part 702 may be performed in another embodiment based on an average colorant usage rate that is determined for another printing device that the end user has or will be returning to a service center in exchange for a new printing device. For example, once the end user has returned his or her existing printing device, with depleted supplies of colorant, the service center may be able to retrieve information from this printing device that indicates how often the end user used each color of colorant. Based on this information, the amount of colorant with which to fill the container of the new printing device can be determined. Alternatively, the service center may be able to determine average colorant usage rate of the returned printing device based on the amount of colorant that is remaining in each of a number of containers of this printing device. This approach may enable the service center to assess whether the end user has used significantly more black colorant than other colors of colorant, for instance, or vice-versa.

As another example, the information within the existing printing device regarding how often the end user used each color of colorant may be retrieved prior to the end user returning this printing device to a service center. For instance, such information may be retrieved by software within the printing device or within a host computing device to which the device is communicatively connected, and sent with the end user's permission over the Internet to the manufacturer of the printing device. Based on this information, the manufacturer of the printing device can provide the end user with an opportunity to order a new printing device with accurate colorant supplies before the existing printing device has depleted its colorant supplies and thus before the existing printing device has reached the end of its projected or rated life.

Once the amount of colorant with which to fill the container has been determined, the container is filled with this amount of colorant (708), and is disposed or affixed within the printing device (710). As has been noted, the container is non-refillable from the perspective of the end user, and is at least substantially permanently affixed within the printing device and non-removable from the printing device from the perspective of the end user. Filling of the container with colorant and/or disposal of the container within the printing device may be performed after or before the end user has provided intended use information of the printing device. In the former instance, the end user may be custom ordering the printing device online, over the phone, or in person, such that filling of the container and/or affixing the container within the printing device is not performed until after the user has provided intended use information. In the latter instance, the end user may be purchasing the printing device in a store in which, as has been described, a number of versions of the same printing device may be offered for sale, where each version corresponds to a different amount of colorant contained within the printing device. In this instance, the container is filled with colorant and is affixed within the printing device prior to the end user implicitly providing intended use information.

The printing device is thus ultimately sold to the end user (712). The end user may be a consumer, such as a home, home office, or educational user using the printing device within a home, home office, or single-person educational setting. The end user may alternatively be an organization, such as a corporation, church, or library, where many people will ultimately be using the printing device, and where these people in total are considered the end user of the printing device. An end user thus encompasses the person or individual who has purchased or who has authorized the purchase of the printing device, and/or the person or people who ultimately use the printing device.

The printing device having the container filled with colorant is sold in one embodiment at a price that permits the manufacturer of the printing device to make a profit on the printing device as well as on the colorant contained within the printing device. That is, the printing device is sold on an up-front pricing model in which the manufacturer makes a profit on the printing device and on the colorant contained within the device at the initial time of sale. Such an up-front pricing model contrasts with an annuity model, where the printing device is initially sold at a profit, at cost, or at a loss, and as the user purchases replacement supplies of colorant, the manufacturer makes more profit on these replacement supplies.

To compensate for the risk inherent to the annuity model, which reflects the fact that the manufacturer does not actually know when or if replacement colorant supplies will be purchased, the replacement supplies may have to be priced at a larger profit margin. As such, the up-front pricing model is advantageous to the manufacturer, since it receives all its profit, on a guaranteed basis, from the end user at the time of sale. The up-front pricing model can also be advantageous to the end user, since the manufacturer may price the printing device to reflect a lower price of colorant than compared to replacement colorant supplies, insofar as the risk of the annuity model is avoided. In addition, the up-front pricing model provides for completely known and transparent pricing to the end user. Whereas with an annuity model the end user cannot be certain of the total costs of colorant supplies that will be incurred, due to changing prices of and need for the colorant supplies, the up-front pricing model ensures that the end user knows at the time of purchase how much the total costs of colorant will be, insofar as they are included in the cost of the printing device.

The end user uses the printing device to form images on media, until the colorant contained within the container has been at least substantially depleted (714). It is noted that some colors of colorant may be depleted before other colorant colors. Various optimizations may be employed by the printing device to substantially use all the colors of colorant, so that the end user achieves the most value from the printing device. For example, if the printing device determines that black colorant is being depleted at a faster rate than expected, or has already been depleted, it may automatically or with approval from the user substitute a composite of the other colors of colorant that approximates black, so that the black colorant can be used more judiciously. As another example, if one particular color of colorant is being used more quickly than expected, or has already been depleted, color mapping may be modified to reduce usage of this colorant color or attempt to hide the lack of this color of colorant.

It is also noted that insofar as the end user is purchasing a printing device that is to last the end user for a relatively long length of time in terms of colorant—such as a number of years, for instance—the printing device may provide a virtual or actual counter of the pages that have been printed by the printing device. This is done so that the user can verify that he or she is getting the full value of the colorant within the printing device that was purchased. A virtual counter in this context means that the printing device tracks the number of pages that have been printed, where this information can be accessed via a printer driver of a host computing device and displayed to the user. An actual counter in this context means that the printing device may display on the device itself the number of pages that have been printed. Besides the number of pages, other information may also be provided to the user, such as the average colorant content or usage on these pages.

Once the end user has substantially depleted the colorant from the printing device (714), in one embodiment the end user returns the printing device to a service center (716). The manufacturer, for example, may provide a return postage-paid shipping container in which the end user can return the printing device to the service center. As another example, the end user may be able to return the printing device to the service center by dropping it off at a store. The advantage of this embodiment is that the end user does not simply throw away the printing device for ultimate deposit within a landfill, although that is an option available to the end user.

When received by the service center, the printing device can be serviced at the service center to at least replenish the colorant contained within the printing device (718). For example, the service center may remove the existing container of colorant, which has been substantially exhausted, and install a new container having a fresh supply of colorant (720). In this sense, it is noted that while the colorant container is non-removable and is permanently affixed to the printing device from the perspective of the end user, the service center may employ personnel that have special training and/or special tools that enable the container to nevertheless be removed, which is something that the end user is more than likely not be able to accomplish.

As another example, the service center may refill the existing depleted container with a fresh supply of colorant (722), in lieu of replacing the depleted container with an entirely new container of colorant. In this sense as well, it is noted that while the colorant container is non-refillable from the perspective of the end user, the service center may employ personnel that have special training and/or special tools that enable the container to nevertheless be refilled, which is something that the end user is more than likely not be able to accomplish. The resulting refurbished printing device can then be resold or sent back to the end user, enabling the base hardware of the printing device, where still operable, to be used again by the same or different end user.

Embodiments of the invention have been described herein in which a printing device is receptive to removable insertion of print cartridges that become fluidically coupled to internal colorant supplies of the device. Those of ordinary skill within the art can appreciate that various permutations, adaptations, and variations can be made to these embodiments without departing from the scope of the invention as claimed. As one example, backpressure-regulating functionality and push-priming functionality, which may ensure proper operation of inkjet-printing devices in particular, may be provided within the print cartridges themselves, or within the printing device apart from the print cartridges, as can be appreciated by those of ordinary skill within the art.

Embodiments of the invention provide for the advantages that have been articulated above, as well as other advantages. For example, a common complaint with printing devices is that on occasion an end user runs out of colorant mid-page during printing, necessitating replacing the depleted supply of colorant with a fresh colorant supply. Having a colorant supply within the printing device that substantially lasts for the life of the printing device ensures that this issue is prevented. That is, substantially the only time the end user will run out of colorant is at the end of the rated or projected life of the printing device. The user, in other words, does not have to concern him or herself that he or she will run out of colorant mid-page during printing.

This is advantageous, because not running out of ink mid-page during printing means that the customer does not waste a sheet of media on which a complete desired image has not been formed. While the price per sheet of plain paper is inexpensive, special photo media can be relatively expensive—costing upwards of two dollars per sheet for some media. As such, the cost of running out of ink mid-page, from a media perspective, can be relatively significant.

It is noted that while embodiments of the disclosure have been described herein in relation to a printing device in which the colorant in question is ink, they are equally applicable to other embodiments in which the colorant is other than ink, such as a toner, in the case of a laser-printing device like a laser printer, for instance. The inkjet printhead that has been described can thus more generally be considered a printing mechanism that forms images on media using the supply of colorant. In the case of a printing device that employs toner, the toner may be or include black-and-white toner and/or one or more different colors of toner.

We claim:

1. A printing device comprising:
a supply of colorant that is non-refillable from an end user perspective and that is at least substantially non-removable from the printing device from the end user perspective; and,
a printing mechanism to form images on media using the supply of colorant.

2. The printing device of claim 1, further comprising:
a print cartridge in which the printing mechanism is disposed and that is configured to use the supply of colorant to form the images on the media, the supply of colorant external to the print cartridge; and,
a mechanism receptive to insertion of the print cartridge.

3. The printing device of claim 2, wherein the print cartridge lacks a self-contained supply of colorant.

4. The printing device of claim 2, wherein the print cartridge has a self-contained supply of colorant that is used to form the images on the media and that is replenished by the supply of colorant of the printing device as the images are formed on the media.

5. The printing device of claim 2, wherein the mechanism comprises a carriage to move across the media.

6. The printing device of claim 1, wherein the supply of colorant is sufficient to last for a rated life of the printing device.

7. The printing device of claim 1, wherein the supply of colorant substantially ensures that an end user will not run out of colorant mid-page during printing, except at an end of a rated life of the printing device.

8. The printing device of claim 1, wherein the supply of colorant comprises toner.

9. A method comprising:
filling a container with colorant, the container being non-refillable from an end user perspective;
disposing the container within a laser printing device, the container at least permanently affixed within the laser printing device from the end user perspective; and,
providing the laser printing device having the container filled with colorant to an end user for use by the end user to form images on media,
wherein the end user does not have to refill the laser printing device with the colorant at any time during usage of the laser printing device to form the images on the media.

10. The method of claim 9, further comprising determining an amount of colorant with which to fill the container.

11. The method of claim 10, wherein determining the amount of colorant with which to fill the container comprises requesting that the end user provide intended use information of the laser printing device.

12. The method of claim 11, wherein determining the amount of colorant with which to fill the container further comprises corresponding the intended use information provided by the end user with the amount of colorant with which to fill the container, so that the colorant is likely to last consistent with the intended use information.

13. The method of claim 11, wherein the intended use information comprises one or more of:
how the laser printing device will be used to form the images on the media;
how often the laser printing device will be used to form the images on the media;
how long the end user wants the colorant within the container to last;
historical colorant usage of other printing devices; and,
special purpose intended use information corresponding to a particular usage scenario.

14. The method of claim 10, wherein the laser printing device is a first printing device, and determining the amount of colorant with which to fill the container comprises determining an average colorant usage rate based on a second laser printing device that the end user has returned or will be returning to a service center.

15. The method of claim 10, wherein the amount of colorant with which the container is filled is less than a maximum amount of colorant that the container is able to contain.

16. The method of claim 9, wherein providing the laser printing device having the container filled with the colorant comprises pricing the laser printing device such that a manufacturer of the laser printing device makes a profit on the laser printing device as well as on the colorant with which the container has been filled.

17. The method of claim 16, wherein the laser printing device is sold using an up-front model in which the manufacturer of the laser printing device makes the profit on the laser printing device and on the colorant with which the container has been filled at time of sale.

18. A method comprising:
an end user using a printing device to form images on media until a container of the printing device that is filled with colorant has been at least substantially depleted, the container being non-refillable from an end user perspective and at least permanently affixed within the printing device from the end user perspective;
the end user returning the printing device to a service center; and,
the service center servicing the printing device to at least replenish the colorant contained within the printing device.

19. The method of claim 18, wherein the service center servicing the printing device comprises:
the service center removing the container from which the colorant has been at least substantially depleted; and,
the service center installing a new container having a fresh supply of the colorant.

20. The method of claim 18, wherein the service center servicing the printing device comprises the service center refilling the container from which the colorant has been at least substantially depleted with a fresh supply of the colorant.
